(19) United States
(12) Patent Application Publication
(10) Pub. No.: US 2005/0063803 A1
(43) Pub. Date: Mar. 24, 2005

(54) Device for the distribution of loose material into at least two hoppers arranged above the mouth of a blast furnace

(76) Inventor: Franz-Josef Irnich, Hurtgenwalt (DE)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/897,967

(22) Filed: Jul. 22, 2004

(30) Foreign Application Priority Data
Jul. 23, 2003 (DE) 103 33 569.2

(51) Int. Cl. B02C 19/00

(52) U.S. Cl. 414/299

(57) ABSTRACT

Device (30) for the distribution of loose material into two hoppers (12′, 12″) arranged above the mouth (11) of a blast furnace. A loose material deflection flap (33) is associated with the inlet openings (31, 32) of the two hoppers (12′, 12″), by means of which flap the two hopper inlet openings (31, 32) can be opened or closed alternately in such a manner that, when one inlet opening (32) is open, the other inlet opening (31) is closed by the deflection flap (33) and vice-versa.

The invention relates to a device for the distribution of loose material into at least two hoppers, especially two hoppers arranged above the mouth of a blast furnace.

A very large number of charging apparatuses of different kinds are known for the charging (mouth-charging) of shaft furnaces or blast furnaces. The primary concern therein is that the charging of the mouth of a blast furnace is uniform over the cross-section thereof. In that respect, reference is made, purely by way of example, to DE 199 29 180 C2, originated by the Applicant.

In the present case, the concern is the distribution of loose material into two loose material hoppers arranged above the mouth of a furnace, the one hopper preferably being charged while the other hopper is being emptied and vice-versa. It will be self-evident that the invention very generally is suitable for the afore-mentioned distribution of loose material into at least two containers.

The present invention is based on the problem of providing a loose material distribution device which is extremely efficient, simple and, especially, of space-saving construction, more especially of low height.

The problem is solved in accordance with the invention by the characterising features of claim 1. An essential aspect of the present invention accordingly consists of the fact that a loose material deflection flap is associated with the inlet openings of the at least two containers, by means of which flap the two container inlet openings can be opened or closed alternately, more specifically in such a manner that, when one inlet opening is open, the other inlet opening is closed by the deflection flap and vice-versa. There is accordingly obtained problem-free deflection and distribution of loose material between the two containers, the deflection flap fulfilling a double function, namely
deflection of loose material,
closure of one container while the other container is being charged and vice-versa.

The container inlet openings preferably extend at a predetermined angle, especially about 90°, with respect to one another, the deflection flap being mounted so that it can pivot back and forth above those two inlet openings, more specifically in the afore-mentioned manner.

An embodiment which is especially simple and robust and, therefore, especially suitable for blast furnace operation is characterised in that the deflection flap is positively guided, at its leading and trailing ends during pivoting, along tracks extending parallel to the container inlet openings.

The deflection flap is preferably driven by way of a pivot lever, which is coupled, on the one hand, to a pivot drive and, on the other hand, to the deflection flap. A specific embodiment is set out in claim 4.

In respect of a preferred specific embodiment of the afore-mentioned positive guidance, reference is made to claim 5.

It is especially important that the guide tracks are arranged on that side of the deflection flap which is directed towards the container inlet openings (the underneath side) and are protected from loose material by the deflection flap. The articulation of the afore-mentioned pivot lever is also effected on the underneath side of the deflection flap, that is to say the side protected from loose material. This makes a substantial contribution to the service life of the deflection and distribution device according to the invention. More especially, the guidance and pivoting devices are also protected from excessive soiling so that the maintenance intervals can be extended.

On that side of the deflection flap which is directed towards the loose material, that is to say the upper side, “armouring” is preferably provided, that being accomplished by the welding-on of highly wear-resistant material. In that respect, reference is made specifically to claim 7.

Stops for a maximum approach or minimum spacing between the deflection flap and the container inlet opening in question on closure of the latter can also be provided at the deflection flap and/or at the guide tracks. It is also, in principle, possible for separate seals also to be provided in order to seal off the container inlet openings.

Finally, separate closure flaps can also be associated with each of the container inlet openings, which closure flaps are preferably arranged on the insides of the containers. In that case, they should preferably be capable of being moved up and to the side, away from the container inlet openings when the latter are unblocked in order that, when the hoppers are filled to a high level, collision with the closure flaps is avoided.

In a specific embodiment, the deflection flap is located below a central opening of a filling funnel above the at least two container inlet openings. That embodiment is, overall, very compact and of low height and is, moreover, protected against wear by virtue of the particular guide track and pivot lever arrangement.

A preferred embodiment of a loose material distribution device according to the invention will be described in greater detail hereinbelow with reference to the accompanying drawings, in which:

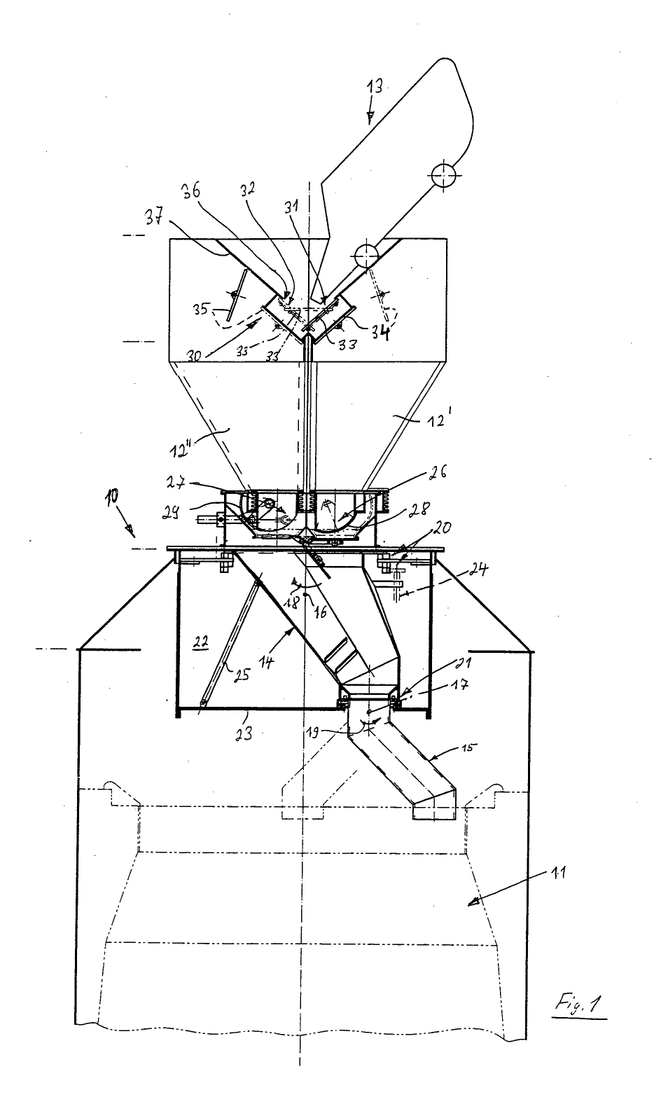

FIG. 1 is a diagrammatic longitudinal section through a furnace end or mouth closing device having material hoppers arranged thereabove;

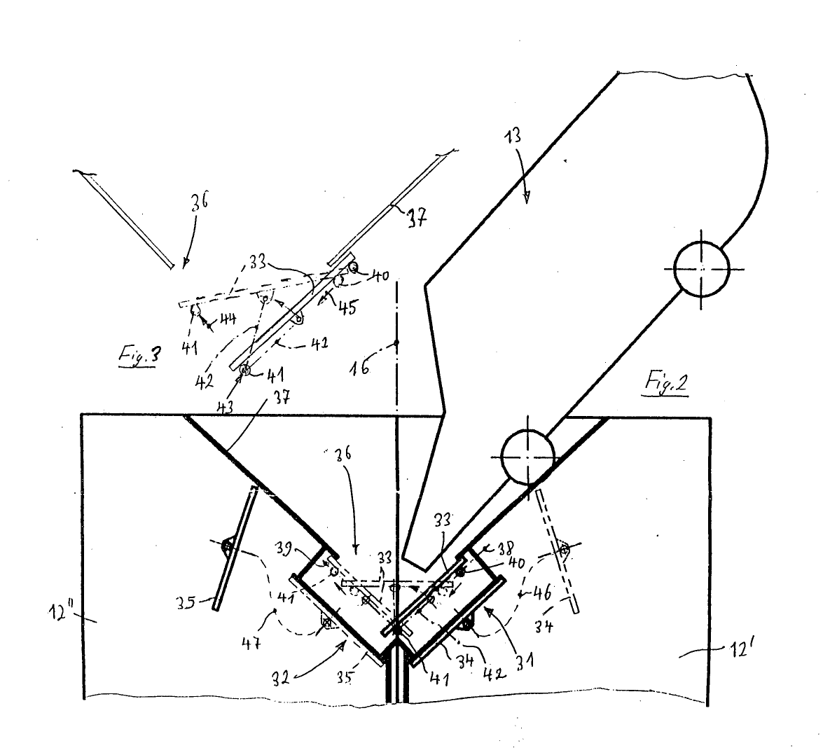

FIG. 2 shows the inlet openings associated with the material hoppers in a view corresponding to FIG. 1 but to an enlarged scale; and

FIG. 3 shows the mode of operation of a material deflection flap associated with the hopper inlet openings, also in a diagrammatic longitudinal section corresponding to that according to FIG. 2.

FIG. 1 shows a furnace end or mouth closing device 10, which is located above the mouth 11 of a blast furnace (not described in further detail hereinbelow). Situated parallel to one another above the furnace end are two material hoppers 12′, 12″, into which loose material is filled by way of a conveyor system, in this instance material chutes 13. The mouth 11 of the furnace is then charged from the material hoppers 12′, 12″ by way of a rotating chute 14 and a distribution and charging chute 15. The rotating chute 14 is driven in rotation about a first vertical axis of rotation 16. At the outlet, that is to say at the bottom end of the rotating chute 14, the distribution and charging chute 15 is mounted so that it is driven in rotation about a second vertical axis of rotation 17, which is laterally offset relative to the first axis of rotation 16. The corresponding rotary movements of the afore-mentioned chutes are indicated by the arrows 18, 19.

The rotary drive of the two chutes 14, 15 is effected by means of associated mechanisms 20, 21, which are arranged, for reasons of protection from temperature and dust, inside the pot-like sealing space 22. The upper mechanism, associated with the rotating chute 14, is also coupled to an electric motor drive (not described in greater detail herein). In addition, transmission of the rotary movement to the lower distribution and charging chute 15 relative to the rotating chute 14, which is oriented on a slant, is effected by way of a mechanical connection 24 (merely indicated herein) between the mechanism 20 associated with the rotating chute 14 and the mechanism 21 associated with the charging chute 15. In that respect reference is made to the arrangement described in DE 199 29 180 C2.

The bottom of the sealing space 22 is closed off by an especially heat-resistant plate 23. That plate constitutes a kind of heat shield. It also encloses the housing of the mechanism 21 associated with the charging chute 15.

The heat shield 23 is mounted so as to be rotatable about the axis 16 together with the rotating chute 14. For that purpose an additional rigid connection in the form of a connecting rod 25 is provided between the rotating chute 14 and the heat shield 23.

The two material hoppers 12′, 12″ each have a separate bottom outlet 26, 27, through which the rotating chute 14 is charged either from the material hopper 12′ or from the material hopper 12″. The bottom outlets 26, 27 can be opened alternately. The corresponding closing flaps are indicated in FIG. 1 by reference numerals 28, 29. In FIG. 1, the left-hand closing flap 29 is shown in the open position, whereas the closing flap 28 associated with the right-hand material hopper 12′ is in the closed position.

Of particular interest in the present case is the device for distributing loose material into the two material hoppers 12′, 12″, which device as a whole is indicated by reference numeral 30. It comprises a loose material deflection flap 33, which is associated with the two inlet openings 31, 32 and by means of which the two container inlet openings 31, 32 can be opened and closed alternately, more specifically in such a manner that, when one inlet opening is open (the left-hand inlet opening 32 in FIG. 1), the other inlet opening 31 is closed by the deflection flap 33 and vice-versa. It is consequently possible to charge either the left-hand or the right-hand material hopper 12′ or 12″. The material hoppers 12′, 12″ are used as intermediate material holders from which the rotating and distribution chutes are fed.

From FIG. 1 it can furthermore be seen that the hopper inlet openings 31, 32 are oriented at an angle of about 90° to one another and that the deflection flap 33 is mounted so that it can pivot back and forth above those two inlet openings 31, 32.

Also associated with the inlet openings 31, 32 are separate closure flaps 34, 35, more specifically on the inside of each of the containers. Each of those separate closure flaps 34, 35 can, as required, be moved up and to the side, away from the container inlet openings 31, 32, when the latter are unblocked. FIG. 1 shows the left-hand inlet opening 32 in the open position whereas the right-hand inlet opening 31 is closed both by the deflection flap 33 and also by the closure flap 34 associated with that inlet opening. The closure flaps 34, 35 are, in their closed position, protected against the action of loose material. The wear on the closure flaps is consequently low. They can be manufactured from a relatively economical material whilst still having a long service life.

The deflection flap 33 is otherwise arranged and active below a central opening 36 of a filling funnel 37 above the two hopper inlet openings 31, 32. FIG. 1 shows very clearly that the loose material distribution device shown and described is an arrangement of extremely compact construction, which is subject to a low degree of wear. The upper side of the deflection flap 33, being exposed to the loose material, also is preferably armoured in order to increase the resistance to wear. Otherwise, all sensitive pivoting and guiding parts are located on the underneath side of the deflection flap 33, which side is protected from loose material, as especially FIGS. 2 and 3 clearly show.

In accordance with those two figures, the deflection flap 33 is positively guided, at its leading and trailing ends during pivoting, along tracks 38, 39 extending parallel to the hopper inlet openings 31, 32. In specific terms, that positive guidance of the deflection flap 33 is defined, on the one hand, by guide rollers 40, 41 arranged at the leading and trailing ends or at the two outer ends of the leading and trailing edges and, on the other hand, by guide tracks or grooves 38, 39 associated therewith and extending approximately parallel to the cross-sectional planes of the hopper inlet openings 31, 32. In such an arrangement, the guide tracks 38, 39 are located on the underneath side of the deflection flap 33, which side is directed towards the hopper inlet openings 31, 32. The tracks are consequently protected from loose material by the deflection flap 33. By that means, the risk of soiling or of increased wear caused thereby is reduced to a minimum.

Otherwise, the deflection flap 33 is coupled, by way of a pivot lever 42, to a pivot drive (not described in greater detail herein and merely indicated by its pivot axis 43) in the form of an electric motor or the like, the said pivot lever 42 being pivotally mounted, on the one hand, on the underneath side of the deflection flap 33, which side is directed towards the hopper inlet openings 31, 32 and, on the other hand, in the corner region between the two hopper inlet openings 31, 32. Otherwise, however, the pivot lever 42 is connected to the drive shaft of a pivot drive (not described in greater detail) for conjoint rotation therewith.

FIG. 3 shows very clearly that, when the deflection flap 33 is pivoted from the right-hand closed position to a left-hand closed position, the guide roller 41 associated with the afore-mentioned corner region moves upwards along the guide track associated with the still open hopper inlet opening 32 in the direction of arrow 44 whereas the other guide roller 40, which is associated with the trailing edge of the deflection flap 33, moves downwards in the direction of arrow 45. The deflection flap 33 is consequently positively guided “around the corner”, that positive guidance being governed by the pivot drive 42, 43.

The deflection flap 33 preferably consists of a frame, especially a rectangular frame, formed by profiled rails, especially U-profile rails, the flat sides of which frame are defined by steel plates. As already mentioned, the upper side, on which loose material acts, is preferably “armoured”, that is to say provided with a highly wear-resistant material. Such armouring is usually obtained by the welding-on of highly wear-resistant material.

Stops for a maximum approach or minimum spacing between the deflection flap 33 and the hopper inlet opening 31, 32 in question on closure of the latter can also be provided at the deflection flap 33 and/or at the guide tracks 38, 39.

It is also, in principle, feasible for the deflection flap also to be provided with sealing strips in order to obtain hermetic sealing of one or other inlet opening 31 and/or 32. However, that is not absolutely necessary, because of the additional closure flaps 34, 35.

The movement of the separate closure flaps 34, 35 up and to the side is indicated in FIG. 2 by corresponding lines 46, 47 of movement. Those lines of movement are approximately S-shaped. Associated with the closure flaps 34, 35 are corresponding guidance elements—more specifically, preferably, in the form of a corresponding multi-lever mechanism. As a result of that kind of movement by the closure flaps 34, 35, it is possible for the hoppers 12′, 12″ to be filled up close to the inlet openings. Despite the comparatively high level of filling, the arrangement can be of relatively compact construction, that is to say of low height, by virtue of the loose material distribution device described. In addition, the described arrangement is distinguished by high resistance to wear and a correspondingly long service life.

All features disclosed in the Application documents are claimed as being essential to the invention insofar as they are novel, either individually or in combination, with respect to the prior art.

### Reference Numerals

10 end of furnace
11 mouth
12′, 12″ material hoppers
13 conveyor system (conveyor chute)
14 rotating chute
15 charging chute
16 axis of rotation
17 axis of rotation
18 arrow
19 arrow
20 mechanism
21 mechanism
22 sealing space
23 plate or heat shield
24 mechanical connection
25 connecting rod
26 bottom outlet
27 bottom outlet
28 closing flap
29 closing flap
30 loose material distribution device
31 inlet opening
32 inlet opening
33 deflection flap
34 closure flap
35 closure flap
36 central opening
37 filling funnel
38 guide track
39 guide track
40 guide roller
41 guide roller
42 pivot lever
43 pivot axis (pivot drive)
44 arrow
45 arrow
46 line of movement
47 line of movement

1. Device for the distribution of loose material into at least two containers, especially two hoppers arranged above the mouth of a blast furnace,
characterised in that
a loose material deflection flap (33) is associated with the inlet openings (31, 32) of the at least two containers (12′, 12″), by means of which flap the two container inlet openings (31, 32) can be opened or closed alternately in such a manner that, when one inlet opening (32) is open, the other inlet opening (31) is closed by the deflection flap (33) and vice-versa.

2. Device according to claim 1,
characterised in that
the container inlet openings (31, 32) are oriented at a predetermined angle, especially about 90°, with respect to one another; and the deflection flap (33) is mounted so that it can pivot back and forth above those two inlet openings (31, 32).

3. Device according to claim 1,
characterised in that
the deflection flap (33) is positively guided, at its leading and trailing ends during pivoting, along tracks (38, 39) extending parallel to the container inlet openings (31, 32).

4. Device according to claim 1,
characterised in that
the deflection flap (33) is coupled, by way of a pivot lever (42), to a pivot drive (43), that pivot lever (42) being pivotally mounted, on the one hand, on that side of the deflection flap (33) which is directed towards the container inlet openings (31, 32) (the underneath side), and, on the other hand, in the corner region between the two container inlet openings (31, 32).

5. Device according to claim 3,
characterised in that
the positive guidance of the deflection flap (33) is defined, on the one hand, by guide rollers (40, 41) arranged at the leading and trailing ends or at the two outer ends of the leading and trailing edges and, on the other hand, by guide tracks or grooves (38, 39) associated therewith and extending approximately parallel to the cross-sectional planes of the container inlet openings (31, 32).

6. Device according to claim 5,
characterised in that
the guide tracks (38, 39) are arranged on that side of the deflection flap (33) which is directed towards the container inlet openings (31, 32) (the underneath side) and are protected from loose material by the deflection flap (33).

7. Device according to claim 1,
characterised in that
the deflection flap (33) consists of a frame, especially a rectangular frame, formed by profiled rails, especially U-profile rails, the flat sides of which frame are defined by steel plates, that side on which loose material acts (the upper side) being preferably “armoured”.

8. Device according to claim 1,
characterised in that
stops for a maximum approach or minimum spacing between the deflection flap (33) and the container inlet opening (31, 32) in question on closure of the latter are provided at the deflection flap (33) and/or at the guide tracks (38, 39).

9. Device according to claim 1,
characterised in that
separate closure flaps (34, 35) are also associated with each of the container inlet openings (31, 32), especially on the insides of the containers.

10. Device according to claim 1,
characterised in that
the deflection flap (33) is arranged and active below a central opening (36) of a filling funnel (37) above the at least two container inlet openings (31, 32).

11. Device according to claim 9,
characterised in that
the separate closure flaps (34, 35) are arranged to be moved up and to the side, away from the container inlet openings (31, 32), when the latter are unblocked.
